(19) United States
(12) Patent Application Publication
(10) Pub. No.: US 2013/0324582 A1
(43) Pub. Date: Dec. 5, 2013

(54) METHODS AND COMPOSITIONS FOR REDUCING FUNGAL INFESTATION AND IMPROVING GRASS QUALITY

(71) Applicant: BAYER CROPSCIENCE LP, Research Triangle Park, NC (US)

(72) Inventors: Richard Rees, Chapel Hill, NC (US); Robert Britt Baker, Cary, NC (US); Michael Newnam, Willow Spring, NC (US)

(73) Assignee: BAYER CROPSCIENCE LP, Research Triangle Park, NC (US)

(21) Appl. No.: 13/774,698

(22) Filed: Feb. 22, 2013

Related U.S. Application Data
(60) Provisional application No. 61/654,353, filed on Jun. 1, 2012.

(51) Int. Cl. A01N 43/90

(52) U.S. Cl. CPC A01N 43/90
USPC 514/410

(57) ABSTRACT

Methods for reducing fungal infestation to a crop or plant by applying a composition including a dithiine-tetracarboximide compound to a crop or plant are described herein. Methods of reducing brown patch and/or dollar spot infestation to a plant or crop are also described herein. The disclosure also provides for methods of improving turfgrass and/or ornamental grass quality.

### CROSS REFERENCE TO RELATED APPLICATION

This application claims the benefit of U.S. Provisional Application No. 61/654,353, filed Jun. 1, 2012, the content of which is incorporated herein by reference in its entirety.

### BACKGROUND

1. Field of the Invention

Methods for reducing fungal infestation to a crop or plant by applying a composition including a dithiine-tetracarboximide compound to a crop or plant are described herein. Methods of reducing brown patch and/or dollar spot infestation to a plant or crop are also described herein. The disclosure also provides for compositions and methods of improving turfgrass and/or ornamental grass quality.

2. Description of Related Art

Grass lawns, ornamental grass, and turf grass are dominant landscape features of many residences and commercial properties. Ornamental grass and turf grass are also increasingly prevalent in gardens and recreational areas, such as golf courses. Given the high visibility of these recreational, residential, and commercial areas, maintaining the color, uniformity, and durability of grass is of continued importance.

A wide variety of grass, such as turfgrass and ornamental grass, is susceptible to fungal disease that negatively influences both the quality and durability of the grass. For example, Brown patch disease results in brown or yellow patches of grass from about six inches to several feet or more in diameter. Brown patch is usually caused by a fungal infestation, for example, by Rhizoctonia species fungus. Grass, such as turfgrass and ornamental grass, is also susceptable to Dollar spot caused by the fungal pathogen Sclerotinia homoeocarpa, in the Sclerotiniaceae family. Dollar spot is a common concern on golf course turf and can results in poor turf quality and appearance.

Thus, there is a need for compositions and methods capable of improving grass quality. There is also a need to reduce fungal infestation and combat common diseases such as dollar spot and brown patch.

### SUMMARY OF THE INVENTION

In an aspect, the disclosure provides for a method of reducing fungi infestation to a crop or plant by applying

(a) a compound of formula (I)

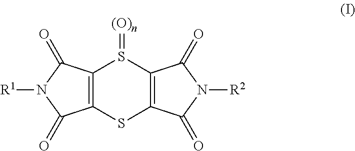

in which

R¹ and R² are identical or different and represent hydrogen, C₁-C₈-alkyl which is optionally monosubstituted or polysubstituted by halogen, —OR³, —COR⁴, or represent C₃-C₇-cycloalkyl which are optionally monosubstituted or polysubstituted by halogen, C₁-C₄-alkyl or C₁-C₄-haloalkyl, or represent aryl or aryl-(C₁-C₄-alkyl), each of which is optionally monosubstituted or polysubstituted by halogen, C₁-C₄-alkyl, C₁-C₄-haloalkyl, —COR⁴ or sulphonylamino,

R³ represents hydrogen, C₁-C₄-alkyl, C₁-C₄-alkylcarbonyl, or represents aryl which is optionally monosubstituted or polysubstituted by halogen, C₁-C₄-alkyl or C₁-C₄-haloalkyl,

R⁴ represents hydroxyl, C₁-C₄-alkyl or C₁-C₄-alkoxy,

n represents 0 or 1; or

an agrochemically acceptable salt thereof; and

(b) an adjuvant

to a plant or crop.

In an aspect a compound of formula (I) and an adjuvant are applied to a crop or plant in separate application steps. In another aspect, or together in the same application step. In another aspect, a compound of formula (I) and an adjuvant are present in a composition.

In an aspect, the disclosure provides for a compound of formula (I) wherein R¹ and R² are identical or different and represent methyl, ethyl, n-propyl or isopropyl. The disclosure provides for a compound of formula (I) R¹ and R² are each methyl or each ethyl and n represents 0.

The disclosure also provides for a method of reducing brown patch and/or dollar spot infestation to a plant or crop by applying a compound of formula (I) to a plant or crop thereof. In an aspect, the disclosure provides for a method for improving turfgrass and/or ornamental grass quality by applying a compound of formula (I) to a plant or crop.

In an aspect, the disclosure provides for a composition including an adjuvant and a compound of formula (I). In another aspect, the disclosure provides for a composition including a non-ionic compound adjuvant blend and/or a non-ionic compound and a phosphated compound adjuvant blend and a compound of formula (I).

The disclosure also provides for a composition described herein with about 0.1% to about 50% by weight of compound formula (I) and about 0.1% to about 10% by weight of an adjuvant.

In an aspect, a composition described herein is applied to a crop or plant at about 100 ga/ha to about 1500 grams/hectare. In another aspect, a composition described herein is applied to a plant or crop at one or more intervals of about 2-7 days, about 7-14 days, about 14-21 days, or about 21-28 days. In yet another aspect, the plant is grass, turfgrass, ornamental grass, or combinations thereof.

### BRIEF DESCRIPTION OF THE DRAWINGS

FIG. 1 sets forth the percentage of Brown Patch infestation on Fairway Grass after composition application at 0, 14, and 28 days. In FIG. 1, (1) represents untreated Fairway grass, (2) represents Compound I-1 applied at 250 grams/hectacre (“GA/HA”) with Silwet L-77 at 1% by volume, (3) represents Compound I-1 applied at 250 GA/HA with Synergen KN at 1% by volume, (4) represents Compound I-1 applied at 500 GA/HA with Synergen KN at 1% by volume, and (5) represents a DACONIL ULTREX® (Syngenta) composition.

FIG. 2 sets forth the turf quality on Fairway grass after composition application at 0, 14, and 28 days from a scale of 1-9. In FIG. 2, (1) represents untreated Fairway grass, (2) represents Compound I-1 applied at 250 grams/hectacre (“GA/HA”) with Silwet L-77 at 1% by volume, (3) represents Compound I-1 applied at 250 GA/HA with Synergen KN at 1% by volume, (4) represents Compound I-1 applied at 500 GA/HA with Synergen KN at 1% by volume, and (5) represents a DACONIL ULTREX® composition.

### DETAILED DESCRIPTION OF A PREFERRED EMBODIMENT

In an aspect, the disclosure provides for a method of treating a plant, crop, seed, or plant part described herein with a composition described herein.

The disclosure also provides for a method of treating grass with a composition described herein. In an aspect, the disclosure provides for a method of treating fungi infestation of grass, for example, fungi infestation of turfgrass or ornamental grass. In yet another aspect, the disclosure provides for a method of controlling, treating, or reducing phytopathogenic fungi to a crop or a plant described herein.

The disclosure also provides for a method of treating dollar spot, brown patch, or a combination of dollar spot and brown patch comprising, consisting of, or consisting essentially of applying a composition described herein to a plant, crop, seed, or plant part described herein. In an aspect, the plant is grass. In another aspect, the plant is turfgrass, ornamental grass, or combinations thereof. The disclosure also provides for a method of improving the quality of grass, such as turf grass or ornamental grass, by applying a composition described herein to grass.

In an aspect, a dithiine-tetracarboximide compound of the general formula (I) can be used with any of the methods described herein:

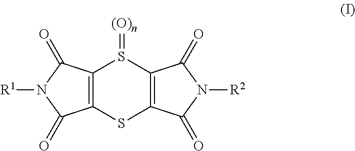

in which

R¹ and R² are identical or different and represent hydrogen, C₁-C₈-alkyl which is optionally monosubstituted or polysubstituted by halogen, —OR³, —COR⁴, or represent C₃-C₇-cycloalkyl which are optionally monosubstituted or polysubstituted by halogen, C₁-C₄-alkyl or C₁-C₄-haloalkyl, or represent aryl or aryl-(C₁-C₄-alkyl), each of which is optionally monosubstituted or polysubstituted by halogen, C₁-C₄-alkyl, C₁-C₄-haloalkyl, —COR⁴ or sulphonylamino,

R³ represents hydrogen, C₁-C₄-alkyl, C₁-C₄-alkylcarbonyl, or represents aryl which is optionally monosubstituted or polysubstituted by halogen, C₁-C₄-alkyl or C₁-C₄-haloalkyl,

R⁴ represents hydroxyl, C₁-C₄-alkyl or C₁-C₄-alkoxy,

n represents 0 or 1.

In another aspect, the disclosure provides for a compound of formula (I) wherein R¹ and R² are identical or different and represent hydrogen or represent C₁-C₆-alkyl which is optionally monosubstituted or polysubstituted by fluorine, chlorine, bromine, —OR³, —COR⁴, or represent C₃-C₇-cycloalkyl which is optionally monosubstituted or polysubstituted by chlorine, methyl or trifluoromethyl, or represent phenyl or phenyl-(C₁-C₄-alkyl), each of which is optionally monosubstituted or polysubstituted by fluorine, chlorine, bromine, methyl, trifluoromethyl, —COR⁴, sulphonylamino.

In an aspect, the disclosure provides for a compound of formula (I) wherein R¹ and R² are identical or different and represent hydrogen, or C₁-C₄-alkyl which is optionally monosubstituted or polysubstituted by fluorine, chlorine, hydroxyl, methoxy, ethoxy, methylcarbonyloxy, carboxyl, or represent C₃-C₇-cycloalkyl which is optionally monosubstituted or polysubstituted by chlorine, methyl or trifluoromethyl, or represent phenyl, benzyl, 1-phenethyl, 2-phenethyl or 2-methyl-2-phenethyl, each of which is optionally monosubstituted to trisubstituted by fluorine, chlorine, bromine, methyl, trifluoromethyl, —COR⁴, sulphonylamino.

In another aspect, the disclosure provides for a compound of formula (I) wherein R¹ and R² are identical or different and represent hydrogen, methyl, ethyl, n-propyl, isopropyl, 2,2-difluoroethyl, 2,2,2-trifluoroethyl, or represent cyclopropyl or cyclohexyl, each of which is optionally substituted by chlorine, methyl or trifluoromethyl.

In an aspect, the disclosure provides for a compound of formula (I) wherein R¹ and R² are identical or different and represent methyl, ethyl, n-propyl or isopropyl, and n represents 0 or 1, or an agrochemically acceptable salt thereof.

In yet another aspect, the disclosure provides for a compound of formula (I) wherein both R¹ and R² are methyl or both R¹ and R² are ethyl.

In an aspect, the disclosure provides for a compound of formula (I) wherein R³ represents hydrogen, methyl, ethyl, methylcarbonyl, ethylcarbonyl or represents phenyl which is optionally monosubstituted or polysubstituted by fluorine, chlorine, methyl, ethyl, n-propyl, isopropyl or trifluoromethyl.

In an aspect, the disclosure provides for a compound of formula (I) wherein R⁴ represents hydroxyl, methyl, ethyl, methoxy or ethoxy.

In an aspect “n” represents 0, 1, 2, or 3.

In another aspect, any of the following compounds can be used with the methods described herein:
Compound (I-1)-2,6-dimethyl-1H,5H-[1,4]dithiino[2,3-c:5,6-c′]dipyrrole-1,3,5,7(2H,6H)-tetrone (i.e. R¹═R²=methyl, n=0)
Compound (I-2)-2,6-diethyl-1H,5H-[1,4]dithiino[2,3-c:5,6-c′]dipyrrole-1,3,5,7(2H,6H)-tetrone (i.e. R¹═R²=ethyl, n=0)
Compound (I-3)-2,6-dipropyl-1H,5H-[1,4]dithiino[2,3-c:5,6-c′]dipyrrole-1,3,5,7(2H,6H)-tetrone (i.e. R¹═R²=propyl, n=0)
Compound (I-4)-2,6-diisopropyl-1H,5H-[1,4]dithiino[2,3-c:5,6-c′]dipyrrole-1,3,5,7(2H,6H)-tetrone (i.e. R¹═R²=isopropyl, n=0)
Compound (I-5)-2,6-dimethyl-1H,5H-[1,4]dithiino[2,3-c:5,6-c′]dipyrrole-1,3,5,7(2H,6H)-tetrone 4-oxide (i.e. R¹═R²=methyl, n=1)

Depending on the nature of the above-defined substituents, the compounds of formula (I) can have acidic or basic properties and can form salts, if appropriate also internal salts, or adducts with inorganic or organic acids or with bases or with metal ions.

In an aspect, suitable metal ions are, for example, ions of the elements of the second main group, in particular calcium and magnesium, of the third and fourth main group, in particular aluminium, tin and lead, and of the first to eighth subgroup, in particular chromium, manganese, iron, cobalt, nickel, copper, and zinc.

If the compounds of the formula (I) have attached to them hydroxyl, carboxyl or other groups which induce acidic properties, in an aspect, these compounds can be reacted with bases to give salts.

Examples of suitable bases are hydroxides, carbonates, hydrogencarbonates of the alkali and alkaline earth metals, in particular those of sodium, potassium, magnesium and calcium, furthermore ammonia, primary, secondary and tertiary amines with (C₁-C₄-)-alkyl radicals, mono-, di- and trialkanolamines of (C₁-C₄)-alkanols, choline and chlorocholine.

If the compounds of the formula (I) have amino, alkylamino or other groups which induce basic properties attached to them, in an aspect, then these compounds can be reacted with acids to give salts.

Examples of inorganic acids are hydrohalic acids such as hydrofluoric acid, hydrochloric acid, hydrobromic acid and hydriodic acid, sulphuric acid, phosphoric acid and nitric acid, and acidic salts such as NaHSO₄ and KHSO₄.

Organic acids are, for example, formic acid, carbonic acid and alkanoic acids such as acetic acid, trifluoroacetic acid, trichloroacetic acid and propionic acid, and also glycolic acid, thiocyanic acid, lactic acid, succinic acid, citric acid, benzoic acid, cinnamic acid, oxalic acid, alkylsulphonic acids (sulphonic acids with straight-chain or branched alkyl radicals having 1 to 20 carbon atoms), arylsulphonic acids or -disulphonic acids (aromatic radicals, such as phenyl and naphthyl, which have one or two sulphonyl groups attached to them), alkylphosphonic acids (phosphonic acids with straight-chain or branched alkyl radicals having 1 to 20 carbon atoms), arylphosphonic acids or aryldiphosphonic acids (aromatic radicals, such as phenyl and naphthyl, which have one or two phosphonic acid radicals attached to them), it being possible for the alkyl or aryl radicals to have attached to them further substituents, for example p-toluenesulphonic acid, salicylic acid, p-aminosalicylic acid, 2-phenoxybenzoic acid, 2-acetoxybenzoic acid etc.

The dithiine-tetracarboximides of the formula (I) which can be used in accordance with the disclosure can be prepared in a manner that is consistent with U.S. Pat. No. 3,364,229, Synthetic Commun. 2006, 36, 3591-3597 and II Farmaco 2005, 60, 944-947, or WO 2010/043319, each of these applications are herein incorporated by reference in their entirety.

The disclosure also provides for a composition comprising, consisting of, or consisting essentially of a compound of formula (I) and an adjuvant, for example, an agriculturally compatable adjuvant.

In an aspect, the adjuvant is an adjuvant blend comprising, consisting of, or consisting essentially of at least one non-ionic compound(s). In another aspect, the adjuvant is an adjuvant blend comprising, consisting of, or consisting essentially of at least one non-ionic compound(s) and at least one phosphate compound(s). In yet another aspect, the adjuvant is an adjuvant blend comprising, consisting of, or consisting essentially of at least one phosphate compound. The disclosure also provides for adjuvants that are tank-mix adjuvants. In an aspect, the adjuvants described herein are amphoteric adjuvants, adjuvants that are polymers of glycerols, amine alkoxylate adjuvants, or quaternary ammonium salt adjuvants. In an aspect, the adjuvant is not water.

Examples of adjuvants suitable for use in the compositions described herein include, for example, the Synergen® family of compositions (Clariant), Synergen® GL 5 (Clariant) Synergen® G2D (Clariant), Synergen® 9903 (Clariant), Synergen® HY (Clariant), Synergen® SW-100 (Clariant) Synergen® BB (Clariant), Synergen® IB-775 (Clariant), Synergen® KN(Clariant), Synergen® G-HL (Clariant), Synergen® S—S (Clariant), or combinations thereof. In yet another aspect, additional adjuvants suitable for use in the compositions described herein include, for example, Vinly Pyrolidone Dimethyl Aminoethyl Methacrylate Copolymers, Acetylanic Diol Surfactants, Acrylate Polymers and derivatives thereof, Aklylbenzene Sulfonate Salts, Aklylbenzene Sulfonates, Alcohol Alkoxylates, Alcohol Phosphates, Alkyl polyglucosides, Alkylated Vinyl Pyrolidone, Alkylpolysaccharides, Amine Alkoxylates, Amine Ethoxylates, Block Copolymers, Castor Oil Ethoxylates, Crosslinked PVP, Dendrimers, Distyryl phenol Ethoxylates, Dodecyl phenol Ethoxylates, Dodecylbenzene sulfonate salts, EO/PO Alkoxylates, EO/PO Nonylphenol, EO-PO Block Copolymers, Ethoxylated methyl esters, Fatty acid dimethyl amides, Fatty Alcohol Ethoxylates, Fatty Amine Ethoxylates, Formaldehyde Condensates, Glymes—glycol diethers, Graft copolymers, Isotridecyl Ethoxylated Methyl Ethers, Isotridecyl Ethoxylates, Lanoiln Derivatives, Maleic Anhydride Copolymer, Methacrylates, Methylated Lignosulfonic Acids and its salts, Mono, di, tri glycerides of fats and oils, Napthalene Sulfonates, Nonyl phenol Ethoxylates, Octyl phenol Ethoxylates, Phosphate Esters EO/PO and EO/PO/EO, Phosphated Tristyryl phenol ethoxylates, Polyacrylate and Carboxylate copolymers, Polyglycerol esters, Polymeric Surfactants, PVP (polyvinyl pyrolidone) homopolymers, Quatenary Esters, Quatenary Salts, Sarcosinates, Sodium Lauryl Sulfate, Sodium Lignosulfonate surfactant blends, Sorbitan Ethoxylate Esters, Sorbitan Fatty Acid Esters, Sorbitan Fatty Ester Ethoxylates, Sulfosuccinates, Taurides and Taurates, Tributyl phenol Ethoxylates, Tristyryl phenol Ethoxylates, Urea Clathrates, Vinly Ether/Maleic Anhydride Copolymer, Vinly Pyrolidone/Styrene block copolymers, Vinyl Ether, Vinyl Pyrolidone/Vinyl Acetate polymers, ethoxylated alcohol compounds, poly(oxy-1,2-ethanediyl), α-isotridecyl-ω-hydroxy-, phosphate, ethoxylated C12-C16 alcohols, or combinations thereof. In another aspect, one or more, two or more, three or more, four or more, or five or more of the adjuvants described herein may be used together.

In another aspect, additional adjuvants suitable for use in the compositions described herein include a blend of phosphate and ethoxylated alcohol compounds, such as a blend of poly(oxy-1,2-ethanediyl), α-isotridecyl-ω-hydroxy-, phosphate and ethoxylated C12-C16 clcohols.

In an aspect, compositions described herein can include about 0.01% to about 1%, about 0.1% to about 1.5%, about 0.5% to about 2%, about 2% to about 5%, about 5% to about 10%, about 10% to about 40%, about 20% to about 80%, about 1% to about 99% by weight of an adjuvant described herein.

In an aspect, the disclosure provides for a composition comprising, consisting of, or consisting essentially of a compound of formula (I) and a surfactant, adjuvant, solvent, carrier, surface-active substance, or extender, and combinations thereof. In another aspect, the components described herein, when used in combination, provide for additive or synergistic properties. In an aspect, compositions described herein can include about 0.01% to about 1%, about 0.1% to about 1.5%, about 0.5% to about 2%, about 2% to about 5%, about 5% to about 10%, about 10% to about 40%, about 20% to about 80%, or about 50% to about 95% by weight of a surfactant, adjuvant, solvent, carrier, surface-active substance, or extender described herein.

In another aspect, the surfactant can be of the emulsifying or wetting type and can be ionic or non-ionic. In another aspect, the disclosure provides for surfactants that are salts of polyacrylic or lignosulfonic acids; salts of phenolsulfonic or naphthalenesulfonic acids; polycondensates of ethylene oxide with fatty alcohols or fatty acids or fatty amines or substituted phenols (particularly alkylphenols or arylphenols); ester-salts of sulfosuccinic acids; taurine derivatives, such as alkyl taurates; phosphoric esters; or esters of alcohols or polyoxyethylated phenols. In an aspect, compositions described herein can include about 0.01% to about 1%, about 0.1% to about 1.5%, about 0.5% to about 2%, about 2% to about 5%, about 5% to about 10%, about 10% to about 40%, about 20% to about 80%, or about 50% to about 95% by weight of a surfactant described herein.

In an aspect, the carrier refers to a natural or synthetic, organic or inorganic substance which is mixed or combined with the active substances for better applicability. The carrier, which may be solid or liquid, is generally inert and, for example, is suitable for use in agriculture.

Suitable solid or liquid carriers can be, for example, ammonium salts and ground natural minerals, such as kaolins, clays, talc, chalk, quartz, attapulgite, montmorillonite or diatomaceous earth, and ground synthetic minerals, such as finely divided silica, alumina and natural or synthetic silicates, resins, waxes, solid fertilizers, water, alcohols, especially butanol, organic solvents, mineral and vegetable oils and derivatives of these. Mixtures of such carriers may also be used. Suitable carriers for granules can be, for example, crushed and fractionated natural minerals, such as calcite, marble, pumice, sepiolite, dolomite, and also synthetic granules of inorganic and organic meals and also granules of organic material, such as sawdust, coconut shells, maize cobs and tobacco stalks.

Suitable liquefied gaseous extenders or carriers can be, for example, liquids which are gaseous at ambient temperature and under atmospheric pressure, for example aerosol propellants, such as halocarbons, and also butane, propane, nitrogen and carbon dioxide.

Tackifiers, such as carboxymethylcellulose and natural and synthetic polymers in the form of powders, granules and latices, such as gum arabic, polyvinyl alcohol, polyvinyl acetate, or else natural phospholipids, such as cephalins and lecithins and synthetic phospholipids can be used in the formulations. Other possible additives include mineral and vegetable oils.

If the extender used is water, it is also possible, for example, to use organic solvents as auxiliary solvents. Suitable liquid solvents can be, for example, aromatic compounds, such as xylene, toluene or alkylnaphthalenes, chlorinated aromatic compounds or chlorinated aliphatic hydrocarbons, such as chlorobenzenes, chloroethylenes or methylene chloride, aliphatic hydrocarbons, such as cyclohexane or paraffins, for example mineral oil fractions, mineral and vegetable oils, alcohols, such as butanol or glycol, and also ethers and esters thereof, ketones, such as acetone, methyl ethyl ketone, methyl isobutyl ketone or cyclohexanone, strongly polar solvents, such as dimethylformamide and dimethyl sulphoxide, and also water.

In another aspect, compositions described herein can comprise surface-active substances. Suitable surface-active substances, for example, are emulsifiers and/or foam formers, dispersants or wetting agents having ionic or nonionic properties, or mixtures of these surface-active substances. Examples of these are salts of polyacrylic acid, salts of lignosulphonic acid, salts of phenolsulphonic acid or naphthalenesulphonic acid, polycondensates of ethylene oxide with fatty alcohols or with fatty acids or with fatty amines, substituted phenols (preferably alkylphenols or arylphenols), salts of sulphosuccinic esters, taurine derivatives (preferably alkyl taurates), phosphoric esters of polyethoxylated alcohols or phenols, fatty esters of polyols, and derivatives of the compounds containing sulphates, sulphonates and phosphates, for example, alkylaryl polyglycol ethers, alkylsulphonates, alkyl sulphates, arylsulphonates, protein hydrolysates, lignin-sulphite waste liquors and methylcellulose. In an aspect, the surface active substance is present in about 1% to about 10% by weight, by about 5% to about 25% by weight, or about 20% to about 50% by weight.

In another aspect, a composition described herein can include a colorant, such as an inorganic pigment, for example phytocyanine, iron oxide, titanium oxide, Prussian blue, and an organic dye, such as alizarin dye, azo dye and metal phthalocyanine dye, and trace nutrient, such as salts of iron, manganese, boron, copper, cobalt, molybdenum and zinc.

In another aspect, a composition described herein may include other additional components, for example protective colloids, binders, adhesives, thickeners, thixotropic substances, penetrants, stabilizers, sequestering agents, complex formers.

The disclosure also provides for a combination of a dithiino-tetracarboximide of formula (I) described herein together with a fungicidally active compound, for example, such as those set forth in US Patent Application No. 20110064827, with an insecticidal active compound, for example, such as those set forth in US Patent Application No. 20110118115. Each of these applications is hereby incorporated by reference in their entirety.

In an aspect, compositions described herein can include, for example, about 0.1% to about 2%, about 2% to about 5%, about 5% to about 10%, about 10% to about 25%, about 5% to about 50%, about 10% to about 80% of an active agent compound described herein, for example, a compound of formula (I), a fungicide, or an insecticidal compound. In another aspect, compositions described herein can include, for example, contain about 0.1%, about 2%, about 5%, about 10%, about 15%, about 20%, about 40%, about 50%, about 60%, or about 75% or more of an active agent compound described herein, for example, a compound of formula (I), a fungicide, or an insecticidal compound.

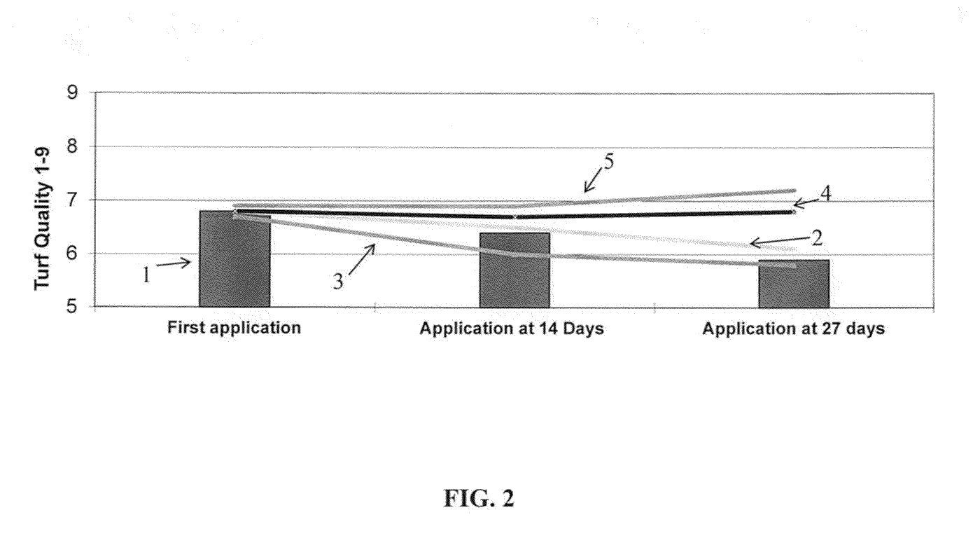

In another aspect, a composition comprising, consisting of, or consisting essentially of a compound of formula (I) together with an adjuvant described herein unexpectedly results in a reduction to brown patch, dollar spot, or a combination of brown patch or dollar spot on grass. In an aspect, a composition comprising, consisting of, or consisting essentially of a compound of formula (I) together with an adjuvant described herein unexpectedly results in a reduction to brown patch, dollar spot, or a combination of brown patch or dollar spot on grass while maintaining or improving grass quality. In an aspect, a composition comprising, consisting of, or consisting essentially of a compound of formula (I) together with an adjuvant described herein unexpectedly results in a reduction to brown patch, dollar spot, or a combination of brown patch or dollar spot on grass while reducing the quality of grass by about 1% to about 2%, about 2% to about 5%, about 5% to about 10%, about 10% to about 20%, or about 25% or less when compared to untreated grass. In yet another aspect, the grass quality is based on a visual score from 1-9, for example, the score set forth in the examples and FIG. 2, with “9” being the top quality score and “1” being the lowest. In another aspect, these properties are present when the composition further comprises a surfactant, adjuvant, solvent, carrier, surface-active substance, or extender, or combinations thereof.

In an aspect, a composition comprising, consisting of, or consisting essentially of a compound of formula (I) together with an adjuvant described herein unexpectedly results in a reduction to brown patch, dollar spot, or a combination of brown patch or dollar spot on grass relative to composition comprising formula (I) in the absence of an adjuvant described herein. In another aspect, a composition comprising, consisting of, or consisting essentially of a compound of formula (I) together with an adjuvant described herein unexpectedly results in a reduction to brown patch, dollar spot, or a combination of brown patch or dollar spot on grass relative to composition comprising chlorothalonil. In yet another aspect, a composition comprising, consisting of, or consisting essentially of a compound of formula (I) together with an adjuvant described herein, unexpectedly results in a reduction to brown patch, dollar spot, or a combination of brown patch or dollar spot on grass relative to a composition comprising chlorothalonil or a composition comprising a compound of formula (I) together with a silicone or siloxane, such as Silwet L-77 (Setre Chemical Company). In another aspect, the grass is a turfgrass or ornamental grass described herein. In another aspect, these properties are present when the composition further comprises a surfactant, adjuvant, solvent, carrier, surface-active substance, or extender, or combinations thereof.

In an aspect, the reduction of brown patch or dollar spot observed with the methods described herein is about 2% to about 10%, about 5% to about 15%, about 10% to about 20%, about 15% to about 35%, about 10% to about 50%, about 50% or more, about 755, or more or about 90% or more relative to an untreated plant, crop, or seed. In another aspect, the reduction in brown patch or dollar spot is relative to a composition comprising a compound of formula (I) together with a silicone or siloxane, such as Silwet L-77.

In an aspect, a composition described herein is applied to a plant, crop, seed, or plant part thereof in a single application step. In another aspect, a composition described herein is applied to a plant, crop, seed, or plant part thereof in a multiple application steps, for example, two, three, four, five or more application steps. In an aspect, the second, third, fourth, or fifth or more application steps may be with the same or different compositions. In yet another aspect, a composition described herein is applied to a plant, crop, seed, or plant part thereof at the time of planting to about 1 day, about 1 day to about 5 days, about 5 days to about 10 days, about 10 days to about 20 days, about 15 days to about 30 days, about 30 to about 100 days, or any combination thereof. In yet another aspect, a composition described herein is applied to a plant, crop, seed, or plant part thereof in one or more application intervals of about 5 days, about 7 days, about 10 days, about 12 days, about 14 days, about 21 days, or about 28 days. In another aspect, a composition described herein is applied to a plant, crop, seed, or plant part thereof in an application regimen at about 1-about 7 days after the first application and followed by a second application at about 10 to about 14 days.

In an aspect a compound of formula (I) and an adjuvant or other agent described herein are applied to a crop or plant in separate application steps. In another aspect, a compound of formula (I) and an adjuvant or other agent described herein are applied to a crop or plant as a composition in the same application step.

In an another aspect, a composition described herein is applied to a plant, crop, seed, or plant part thereof in a preventative manner prior to the appearance to a disorder, such as brown patch or dollar spot in grass. In yet another aspect, a composition described herein is applied to a plant, crop, seed, or plant part thereof in a after the appearance to a disorder, such as brown patch or dollar spot in grass. The disclosure also provides for a method of applying a composition described herein is applied to a plant, crop, seed, or plant part thereof at regular intervals, such as about 3 to about 10 days apart, about 5 to about 7 days apart, or about 7 days apart.

In an aspect, compositions described herein can be used as in the form of suspension concentrates, aerosols, capsule suspensions, cold-fogging concentrates, warm-fogging concentrates, encapsulated granules, fine granules, flowable concentrates for the treatment of seed, ready-to-use solutions, dustable powders, emulsifiable concentrates, oil-in-water emulsions, water-in-oil emulsions, macrogranules, microgranules, oil-dispersible powders, oil-miscible flowable concentrates, oil-miscible liquids, foams, pastes, pesticide-coated seed, suspoemulsion concentrates, soluble concentrates, suspensions, wettable powders, soluble powders, dusts and granules, water-soluble granules or tablets, water-soluble powders for the treatment of seed, wettable powders, natural products and synthetic substances impregnated with active substance, and also microencapsulations in polymeric substances and in coating materials for seed, and also ULV cold-fogging and warm-fogging formulations.

In another aspect, compositions described herein can be prepared, for example, by mixing an active substance with at least one surfactant, extender, solvent or diluent, emulsifier, dispersant and/or binder or fixing agent, wetting agent, water repellant, if appropriate siccatives and UV stabilizers and, if appropriate, dyes and pigments, defoamers, preservatives, secondary thickeners, adhesives, gibberellins and also further processing auxiliaries.

In an aspect, compositions described herein can comprise ready-to-use compositions which can be applied with suitable apparatus to the plant or the seed. In another aspect, the compositions described herein can be used in commercial concentrates which are diluted with water prior to use.

In another aspect, compositions described herein can be combined with an additional actives agent, for example, an insecticide, attractant, sterilant, bactericide, acaricide, nematicide, fungicide, growth regulator, herbicide, fertilizer, safener, or biological control agent.

Examples of fertilizers capable of being used with the compositions and methods described herein include, for example, Urea, Ammonium Nitrate, Ammonium Sulfate, Calcium Nitrate, Diammonium Phosphate, Monoammonium phosphate, Triple Super Phosphate, Potassium Nitrate, Potassium nitrate, nitrate of potash, Potassium Chloride, muriate of potash, di and mono potassiumaiusm salts of phosphite/phosphonate.

The disclosure also provides for applying compositions described herein to plants, crops, seeds, or plant parts described herein by utilizing, for example, dipping, spraying, atomizing, irrigating, evaporating, dusting, fogging, broadcasting, foaming, painting, spreading-on, drenching, or drip irrigating techniques.

In an aspect, compositions described herein can be used for curative or protective control in conditions of reduced water irrigation. For example, compositions described herein can be applied to plant and/or soil before temporary or sustained periods of reduced water irrigation are anticipated. In another aspect, compositions described herein can be applied to plants, crops, and/or soil during temporary or sustained periods of reduced water irrigation.

Plant parts are understood to mean all parts and organs of plants above and below the ground, such as shoot, leaf, flower and root, examples of which include leaves, needles, stalks, stems, flowers, fruit bodies, fruits, seeds, roots, tubers and rhizomes. Parts of plants also include harvested plants and vegetative and generative propagation material, for example seedlings, tubers, rhizomes, cuttings and seeds.

The compositions described herein can be applied to the plants, parts of the plants, seeds of the plants or the area under cultivation (soil of a field). In an aspect, the present compositions are applied as a foliar spray. In an embodiment, the present compositions are applied with sufficient water volumes for adequate coverage of foliage, according to the turf growth stage.

In an aspect, compositions described herein can be applied to grass, for example, those used for lawns or other ornamental purposes, such as turfgrass and ornamental grass, and those used as food or to produce grain for human or animal consumption. Some grasses, such as rye grasses, can be used both for food and for esthetic purposes.

In an aspect, compositions described herein are applied to ornamental grass, for example, to sedges (Cyperaceae), rushes (Juncaceae), restios (Restionaceae), and cat-tails (Typhaceae).

In an aspect, compositions described herein are applied to turfgrass, for example, cool season turfgrasses and warm season turfgrasses. Turf species that the described compositions can be used on include creeping bent grass, colonial bent grass, annual bluegrass, other Poa species of grasses, Bermuda grass, Rye grass, and other common grasses of golf courses, sport fields, commercial recreational areas, and sod farms.

Examples of cool season turfgrasses can include, for example, bluegrasses (Poa spp.), such as Kentucky bluegrass (Poa pratensis L.), rough bluegrass (Poa trivialis L.), Canada bluegrass (Poa compressa L.), annual bluegrass (Poa annua L.), upland bluegrass (Poa glaucantha Gaudin), wood bluegrass (Poa nemoralis L.), and bulbous bluegrass (Poa bulbosa L.); the bentgrasses and redtop (Agrostis spp.), such as creeping bentgrass (Agrostis palustris Huds.), colonial bentgrass (Agrostis tenuis Sibth.), velvet bentgrass (Agrostis canina L.), South German Mixed Bentgrass (Agrostis spp. including Agrostis tenius Sibth., Agrostis canina L., and Agrostis palustris Huds.), and redtop (Agrostis alba L.); the fescues (Festucu spp.), such as red fescue (Festuca rubra L. spp. rubra), creeping fescue (Festuca rubra L.), chewings fescue (Festuca rubra commutata Gaud.), sheep fescue (Festuca ovina L.), hard fescue (Festuca longifolia Thuill.), hair fescue (Festucu capillata Lam.), tall fescue (Festuca arundinacea Schreb.), meadow fescue (Festuca elanor L.); the ryegrasses (Lolium spp.), such as annual ryegrass (Lolium multiflorum Lam.), perennial ryegrass (Lolium perenne L.), italian ryegrass (Lolium multiflorum Lam.); and the wheatgrasses (Agropyron spp.), such as fairway wheatgrass (Agropyron cristatum (L.) Gaertn.), crested wheatgrass (Agropyron desertorum (Fisch.) Schult.), and western wheatgrass (Agropyron smithii Rydb.). Other cool season turfgrasses include beachgrass (Ammophila breviligulata Fern.), smooth bromegrass (Bromus inermis Leyss.), cattails such as Timothy (Phleum pratense L.), sand cattail (Phleum subulatum L.), orchardgrass (Dactylis glomerata L.), weeping alkaligrass (Puccinellia distans (L.) Parl.) and crested dog's-tail (Cynosurus cristatus L.).

Examples of ornamental grass can include, for example, Andropogon gerardii, Miscanthus sinensis ‘Gracillimus’, Muhlenbergia capillaris, Panicum virgatum ‘Shenandoah, Schizachyrium scoparium, and Calamagrostis×acutiflora. Examples of cool season ornamental grasses include, for example, autumn moor grass (Sesleria species), blue oat grass (Helictotrichon species), tufted hair grass (Deschampsia species), fescue grass (Festuca species), examples of warm season ornamental grasses include, for example, northern sea oats (Chasmanthium latifolium), fountain grass (Pennisetum species), and switch grass (Panicum species), examples of ornamental grasses for dry sites include, for example, little blue stem (Schizachyrium scoparium), needle grass (Stipa spartea), june grass (Koeleria macrantha) and western wheatgrass (Agropyron smithii), examples of ornamental grasses for moderately moist sites include, for example, tufted hair grass, northern sea oats, switch grass, Miscanthus species and Calamagrostis species, examples of clumping ornamental grasses include, for example, little bluestem grass, love grass (Eragrostis species), blue oat grass, tufted hair grass and Calmagrostis species, examples of running ornamental grasses include, for example, blue lyme grass (Leymus arenarius), strawberry and cream grass (Phalaris arundinacea) and cord grass (Spartina species).

Examples of warm season turfgrasses can include, for example, Bermudagrass (Cynodon spp. L. C. Rich), zoysiagrass (Zoysia spp. Willd.), St. Augustine grass (Stenotaphrum secundatum Walt Kuntze), centipedegrass (Eremochloa ophiuroides Munro Hack.), carpetgrass (Axonopus affinis Chase), Bahia grass (Paspalum notatum Flugge), Kikuyugrass (Pennisetum clandestinum Hochst. ex Chiov.), buffalo grass (Buchloe dactyloids (Nutt.) Engelm.), Blue gramma (Bouteloua gracilis (H.B.K.) Lag. ex Griffiths), seashore paspalum (Paspalum vaginatum Swartz) and sideoats grama (Bouteloua curtipendula (Michx. Torr.).

Examples of grasses that can be utilized as crops include, for example, corn or maize (Zea mays), sorghum (Sorghum sudanense), switchgrass (Panicum virgatum), millet (Panicum miliaceum), rice (Oryza spp.), wheat (Triticum spp.), oats (Avena spp.), barley (Hordeum spp.), and rye (Secale cereale).

In an aspect, compositions described herein may be applied to healthy or diseased turfs. Prophylactic application to turf before conditions of reduced water irrigation may be helpful in reducing water stress and improving turf quality, density, color, and/or plant cell turgidity. In yet another aspect, compositions described herein can be used to treat one or more turf diseases, such as dollar spot, brown patch, anthracnose, gray leaf spot, and diseases of golf courses, sport fields, and sod farms.

Brown patch is believed to be turfgrass disease that is caused by the Rhizoctonia species fungus. Dollar spot is believed to be caused by the fungal pathogen Sclerotinia homoeocarpa, in the Sclerotiniaceae family. In an aspect, compositions described herein treat fungal infestation. In yet another aspect, compositions described herein treat or reduce Sclerotiniaceae family fungal infestation, for example Sclerotinia homoeocarpa, infestation, and/or Rhizoctonia species fungal infestation. In another aspect, compositions described herein improve turf quality, density, color, and/or plant cell turgidity during reduced water conditions in the summer.

In yet another aspect, compositions described herein are used for the prevention or alleviation of stress from drought, solar radiation, and other oxidative processes on turfgrass located, for example, on sod farms, golf courses, sport fields, parks, residential and commercial sites. In an embodiment, compositions described herein are applied as preventative applications prior to the occurrence of adverse weather conditions or before watering restrictions are imposed, and the applications are repeated at intervals described herein. The present compositions can be applied at higher rates under severe drought conditions or irrigation reductions. In an embodiment, the present compositions are used in conjunction with best turf management practices as is well known to one of ordinary skill in the art.

In an aspect, use of the compositions described herein can result in at least one of the following characteristics: better drought tolerance; improved water utilization; saves water expenses; reduces need for hand watering; retains turf quality through summer stress; reduces plant stress thus requiring less watering; reduces afternoon syringing (i.e., a light application of water to turf foliage; enhances disease resistance from a healthier root system; provides enhanced plant health to minimize water uptake requirements; drought stress protection; water optimization; reduces water needs; causes turf grass exits dormancy for faster green-up; provides more efficient root uptake of surrounding soil moisture; reduces irrigation budget; reduces cost of watering; reduces irrigation needs; and greener lawn with less water requirements.

In an aspect, compositions described herein can be applied to a plant, crop, or plant part described herein from about 0.1 to about 5000 grams/hectare (“ga/ha”), from about 1 and 1500 ga/ha, from about 100 ga/ha to about 1500 ga/ha, from about 300 ga/ha to about 1300 ga/ha, from about 400 ga/ha to about 1000 ga/ha, from about 300 ga/ha to about 500 ga/ha, from about 700 ga/ha to about 1000 ga/ha, or from about 1000 ga/ha to about 1500 ga/ha. In an aspect, the compositions described herein can be applied to a seed at about 0.001 to about 50 gram per kilogram of seed, or at about 0.01 and 10 gram per kilogram of seed.

The compositions of the invention can be applied by known methods. In an aspect, a composition described herein is formulated as a concentrate to be diluted upon use. In another aspect, the components are separately formulated and then mixed in a tank. In yet another aspect, the concentrated formulations of the individual active substances are mixed with water in the tank and the resulting spray mixture being applied.

In an aspect, methods and compositions presented herein are directed to growing a plant under a condition of reduced water irrigation. In another aspect, methods and compositions presented herein are directed to improving plant quality, density, color, and/or plant cell turgidity under a condition of reduced water irrigation.

As used herein, the term “water irrigation” includes external irrigation, such as watering through sprinklers, hoses, and watering pipes, for example. The term “water irrigation” also includes natural irrigation, such as watering through rain, fog, and dew, for example.

As used herein, the term “reduced water irrigation” includes temporary and sustained periods of drought. Periods of reduced water irrigation ranges from about one day to about 6 months. For instance, periods of reduced water irrigation can span a season, such as a summer season. Period can range from about one day to about one week, from about one day to about one month, from about one month to about three months. Periods of reduced water irrigation can also be referred to as “dry down” periods.

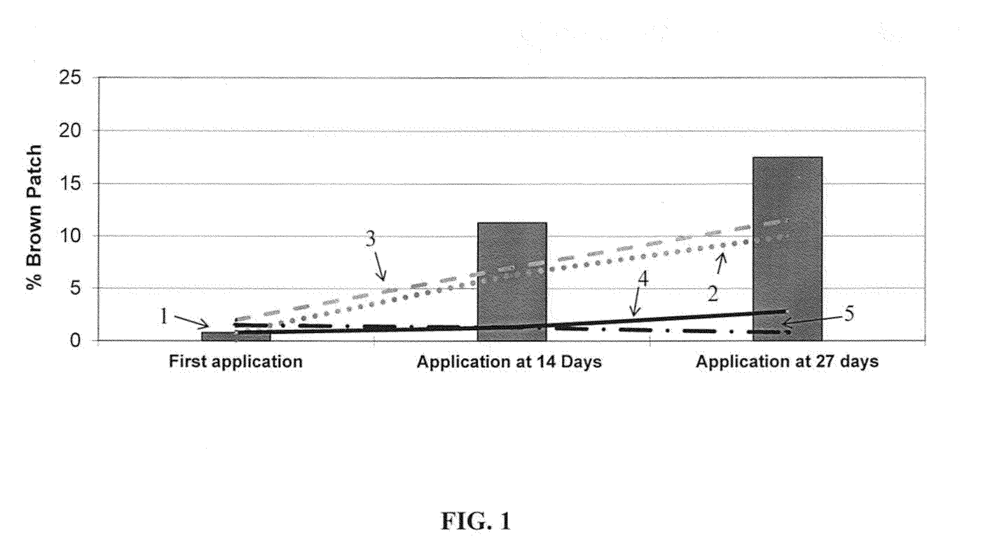

In another aspect, the disclosure provides for a kit comprising, consisting essentially of, or consisting of any of the compositions disclosed herein. In an aspect, the kit includes any of the combination of compositions described in Examples 1-3, FIGS. 1-2, or Tables 1-3. In another aspect, the kit provides for the compositions described in Examples 1-3, FIGS. 1-2, or Tables 1-3 applied in a manner that is consistent with the methodology of these examples and figures. In another aspect, the kit provides instructions or guidance regarding the use of the compositions or methods described herein.

In an aspect, the kit includes instructions describing the methodology described herein. In another aspect, the kit includes instructions describing the methodology set forth in any of Examples 1-3, FIGS. 1-2, or Tables 1-3. In an aspect, the instructions are included with the kit, separate from the kit, in the kit, or are included on the kit packaging.

The following examples serve to illustrate certain aspects of the disclosure and are not intended to limit the disclosure.

### Example 1

Example 1 sets forth the Dollar Spot infestation on Bentgrass Green.

A suspension concentrate composition of Compound I-1 as defined herein with and without the addition of Synergen® KN was applied to Bentgrass Green at 0, 6, and 14 days using a knapsack sprayer. Synergen® KN contains a blend of phosphate and ethoxylated alcohol compounds, such as a blend of poly(oxy-1,2-ethanediyl), α-isotridecyl-ω-hydroxy-, phosphate and ethoxylated C12-C16 alcohols.

In Table 1, untreated Bentgrass Green (1) was compared to a composition including Compound I-1 at 440 grams/hectacre (“GA/HA”) (2), a composition including Compound I-1 at 440 GA/HA+Synergen® KN at 1% by volume (3), a composition including Compound I-1 at 880 GA/HA (4), a composition including Compound I-1 at 880 GA/HA+Synergen® KN at 1% by volume (5), a composition including Compound I-1 at 1320 GA/HA (6), and composition including a Compound I-1 at 1320 GA/HA+Synergen® KN at 1% by volume (7). As set forth in Table 1, ratings were evaluated at −1, 6, 13, 22, 28, 35, and 48 days.

TABLE 1
Percentage of Dollar Spot

| | Day | Day | Day | Day | Day | Day | Day |
|---|---|---|---|---|---|---|---|
| | −1 | 6 | 13 | 22 | 28 | 35 | 48 |
| 1. UNTREATED | 9.5 | 7.5 | 11.3 | 13.8 | 18.3 | 23.8 | 27.5 |
| 2. Compound I-1 at | 8.3 | 7.5 | 10.8 | 12.8 | 14.5 | 19.5 | 22.8 |
| 440 GA/HA | | | | | | | |
| 3. Compound I-1 at | 8.3 | 7.3 | 7.8 | 7.8 | 7.8 | 9.5 | 11.8 |
| 440 GA/HA + | | | | | | | |
| Synergen ® KN at | | | | | | | |
| 1% by volume | | | | | | | |
| 4. Compound I-1 at | 8.3 | 7.8 | 10.5 | 11.3 | 12.5 | 17 | 20.8 |
| 880 GA/HA | | | | | | | |
| 5. Compound I-1 at | 8.3 | 7 | 7.5 | 6 | 5.5 | 7.5 | 8.8 |
| 880 GA/HA + | | | | | | | |
| Synergen ® KN at | | | | | | | |
| 1% by volume | | | | | | | |
| 6. Compound I-1 at | 9 | 8.3 | 10.5 | 12.8 | 14.8 | 17 | 20 |
| 1320 GA/HA | | | | | | | |
| 7. Compound I-1 at | 8.5 | 8.5 | 8 | 5.8 | 4.8 | 5.8 | 6.5 |
| 1320 GA/HA + | | | | | | | |
| Synergen ® KN at | | | | | | | |
| 1% by volume | | | | | | | |

### Example 2

Example 2 sets forth the percentage of Brown Patch infestation on Fairway grass.

FIG. 1 and Table 2 describe the percentage of Brown Patch infestation on Fairway grass (“Fairway”) after composition application at 0, 14, and 28 days. In FIG. 1 and Table 2, (1) untreated Fairway grass was compared to a wettable powder composition including (2) Compound I-1 applied at 250 grams/hectacre (“GA/HA”) with Silwet L-77 at 1% by volume, (3), a wettable powder composition including (3) Compound I-1 applied at 250 GA/HA with Synergen® KN at 1% by volume, a wettable powder composition including (4) Compound I-1 applied at 500 GA/HA with Synergen KN at 1% by volume, and (5) a 8.060 kg ai/ha composition DACONIL ULTREX®.

TABLE 2

| | First | Application | Application |
|---|---|---|---|
| | application | at 14 Days | at 27 days |
| | (percent | (percent | (percent |
| | brown patch | brown patch | brown patch |
| Composition | infestation) | infestation) | infestation) |
| (1) UNTREATED | 0.8 | 11.3 | 17.5 |
| (2) Compound I-1 at | 0.8 | 6.3 | 10 |
| 250 ga/ha + Silwet | | | |
| L-77 at 0.1% V/V | | | |
| (3) Compound I-1 at | 2 | 7 | 11.5 |
| 250 ga/ha + Synergen ® | | | |
| KN at 0.1% V/V | | | |
| (4) Compound I-1 at | 0.8 | 1.3 | 2.8 |
| 500 ga/ha + Synergen ® | | | |
| KN at 0.1% V/V | | | |
| (5) DACONIL ULTREX ® | 1.5 | 1.3 | 0.8 |
| at 8.060 kg ai/ha | | | |

### Example 3

Example 3 sets forth the turf quality on Fairway grass after composition application.

FIG. 2 and Table 3 describes the turf quality on Fairway grass after composition application at 0, 14, and 28 days. As described in FIG. 2 and Table 3, the turf quality was measured on a scale from 1-9, with “9” being the best quality and “1” being the worst quality. In FIG. 1, (1) untreated Fairway grass was compared to a wettable powder composition including (2) Compound I-1 applied at 250 grams/hectacre (“GA/HA”) with Silwet L-77 at 1% by volume, (3), a wettable powder composition including (3) Compound I-1 applied at 250 GA/HA with Synergen® KN at 1% by volume, a wettable powder composition including (3) Compound I-1 applied at 500 GA/HA with Synergen® KN at 1% by volume, and (5) a 8.060 kg ai/ha composition of DACONIL ULTREX®.

TABLE 3

| | First | Application | Application |
|---|---|---|---|
| | application | at 14 Days | at 27 days |
| | (Turf Quality | (Turf Quality | (Turf Quality |
| Composition | 1-9) | 1-9) | 1-9) |
| (1) UNTREATED | 6.8 | 6.4 | 5.9 |
| (2) Compound I-1 at | 6.8 | 6.5 | 6.1 |
| 250 ga/ha + Silwet | | | |
| L-77 at 0.1% V/V | | | |
| (3) Compound I-1 at | 6.7 | 6 | 5.8 |
| 250 ga/ha + Synergen ® | | | |
| KN at 0.1% V/V | | | |
| (4) Compound I-1 at | 6.8 | 6.7 | 6.8 |
| 500 ga/ha + Synergen ® | | | |
| KN at 0.1% V/V | | | |
| (5) DACONIL ULTREX ® | 6.9 | 6.9 | 7.2 |
| at 8.060 kg ai/ha | | | |

1. A method of reducing fungi infestation to a plant or crop comprising applying
(a) a compound of formula (I) 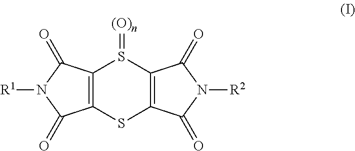
in which
R¹ and R² are identical or different and represent hydrogen, C₁-C₈-alkyl which is optionally monosubstituted or polysubstituted by halogen, —OR³, —COR⁴, or represent C₃-C₇-cycloalkyl which are optionally monosubstituted or polysubstituted by halogen, C₁-C₄-alkyl or C₁-C₄-haloalkyl, or represent aryl or aryl-(C₁-C₄-alkyl), each of which is optionally monosubstituted or polysubstituted by halogen, C₁-C₄-alkyl, C₁-C₄-haloalkyl, —COR⁴ or sulphonylamino,
R³ represents hydrogen, C₁-C₄-alkyl, C₁-C₄-alkylcarbonyl, or represents aryl which is optionally monosubstituted or polysubstituted by halogen, C₁-C₄-alkyl or C₁-C₄-haloalkyl,
R⁴ represents hydroxyl, C₁-C₄-alkyl or C₁-C₄-alkoxy,
n represents 0 or 1; or
an agrochemically acceptable salt thereof; and
(b) an adjuvant
to said plant or crop.

2. The method of claim 1, wherein R¹ and R² are identical or different and represent methyl, ethyl, n-propyl or isopropyl.

3. The method of claim 1, wherein R¹ and R² are each methyl and n represents 0.

4. The method of claim 1, wherein said adjuvant comprises an adjuvant blend comprising a non-ionic compound.

5. The method of claim 1, wherein said adjuvant comprises an adjuvant blend comprising a non-ionic compound and a phosphated compound.

6. The method of claim 1, wherein said plant is grass.

7. The method of claim 6, wherein said grass is turfgrass, ornamental grass, or combinations thereof.

8. The method of claim 1, wherein said method comprises applying a composition comprising about 0.1% to about 50% by weight of said compound formula (I) to said plant or crop.

9. The method of claim 1, wherein said method comprises applying a composition comprising about 0.1% to about 10% by weight of said adjuvant to said plant or crop.

10. The method of claim 1, wherein the combination of (a) and (b) are applied to said crop or plant at about 100 ga/ha to about 1500 grams/hectare.

11. The method of claim 1, wherein the combination of (a) and (b) are applied to said plant or crop at one or more intervals of about 2-7 days, about 7-14 days, about 14-21 days, or about 21-28 days.

12. A method for reducing brown patch and/or dollar spot infestation to a plant or crop comprising applying
(a) a compound of formula (I) 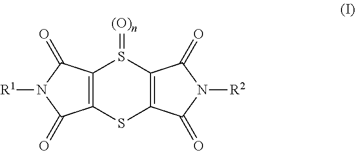
in which
R¹ and R² are identical or different and represent hydrogen, C₁-C₈-alkyl which is optionally monosubstituted or polysubstituted by halogen, —OR³, —COR⁴, or represent C₃-C₇-cycloalkyl which are optionally monosubstituted or polysubstituted by halogen, C₁-C₄-alkyl or C₁-C₄-haloalkyl, or represent aryl or aryl-(C₁-C₄-alkyl), each of which is optionally monosubstituted or polysubstituted by halogen, C₁-C₄-alkyl, C₁-C₄-haloalkyl, —COR⁴ or sulphonylamino,
R³ represents hydrogen, C₁-C₄-alkyl, C₁-C₄-alkylcarbonyl, or represents aryl which is optionally monosubstituted or polysubstituted by halogen, C₁-C₄-alkyl or C₁-C₄-haloalkyl,
R⁴ represents hydroxyl, C₁-C₄-alkyl or C₁-C₄-alkoxy,
n represents 0 or 1; or
an agrochemically acceptable salt thereof; and
(b) an adjuvant
to said plant or crop.

13. The method of claim 12, wherein R¹ and R² are identical or different and represent methyl, ethyl, n-propyl or isopropyl.

14. The method of claim 12, wherein R¹ and R² are each methyl and n represents 0.

15. The method of claim 12, wherein said adjuvant comprises an adjuvant blend comprising a non-ionic compound and a phosphated compound.

16. The method of claim 12, wherein said plant is grass.

17. The method of claim 16, wherein said grass is turfgrass, ornamental grass, or combinations thereof.

18. The method of claim 12, wherein said method comprises applying a composition comprising about 0.1% to about 50% by weight of said compound of formula (I) to said plant or crop.

19. The method of claim 12, wherein said method comprises applying a composition comprising about 0.1% to about 10% by weight of said adjuvant to said plant or crop.

20. A method for improving turfgrass and/or ornamental grass quality comprising applying
(a) a compound of formula (I) 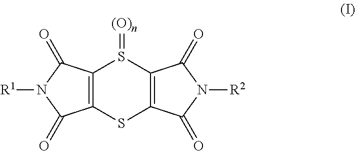
in which
R¹ and R² are identical or different and represent hydrogen, C₁-C₈-alkyl which is optionally monosubstituted or polysubstituted by halogen, —OR³, —COR⁴, or represent C₃-C₇-cycloalkyl which are optionally monosubstituted or polysubstituted by halogen, C₁-C₄-alkyl or C₁-C₄-haloalkyl, or represent aryl or aryl-(C₁-C₄-alkyl), each of which is optionally monosubstituted or polysubstituted by halogen, C₁-C₄-alkyl, C₁-C₄-haloalkyl, —COR⁴ or sulphonylamino,
R³ represents hydrogen, C₁-C₄-alkyl, C₁-C₄-alkylcarbonyl, or represents aryl which is optionally monosubstituted or polysubstituted by halogen, C₁-C₄-alkyl or C₁-C₄-haloalkyl,
R⁴ represents hydroxyl, C₁-C₄-alkyl or C₁-C₄-alkoxy,
n represents 0 or 1; or
an agrochemically acceptable salt thereof; and
(b) an adjuvant
to said turfgrass and/or said ornamental grass.
